(19) United States
(12) Patent Application Publication
(10) Pub. No.: US 2002/0118674 A1
(43) Pub. Date: Aug. 29, 2002

(54) Key distribution mechanism for IP environment

(76) Inventors: Stefano M. Faccin, Dallas, TX (US); Franck Le, Irving, TX (US)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/080,393

(22) Filed: Feb. 25, 2002

Related U.S. Application Data
(60) Provisional application No. 60/270,619, filed on Feb. 23, 2001.

(51) Int. Cl. H04L 12/28

(52) U.S. Cl. 370/352; 370/401

(57) ABSTRACT

A method and apparatus are provided for exchanging Diffie Hellman keys. This may include generating and transferring a first key at a user (such as a mobile node) and generating and transferring the first key to a first domain (such as a home domain). The first key may be certified at the first domain. A second key may be generated at a peer entity and transferred to the first domain. The second key may be certified at the first domain. After being certified, the first key may be transferred to the peer entity and the second key may be transferred to the user. Accordingly, the peer entity and the user are able to exchange their Diffie Hellman information in an authenticated manner and can derive the shared session key.

This application claims priority under 35 U.S.C. §119(e) from U.S. Provisional Application No. 60/270,619, filed Feb. 23, 2001, the subject matter of which is incorporated herein by reference.

### FIELD

The present invention is directed to a key distribution procedure. More particularly, the present invention is directed to a key distribution procedure based on Diffie Hellman for Mobile IPv6 and other IP networks.

### BACKGROUND

Mobile devices such as cellular phones, Personal Digital Assistants (PDA), laptop computers, etc. are abundant in today's society. A large number of people carry mobile phones daily as they travel from home to work and to other places during their day. In most cases, the mobile device has a subscription with a home domain. This home domain keeps information about the user such as a long-term key for security procedures but also information regarding the services the user has subscribed and is therefore authorized to have access to, etc.

When a mobile device/node roams to a foreign domain (i.e., a visited domain), the user of the mobile device needs to be authorized by the foreign domain to gain access to local resources of the visited domain. The authorization generally consists of the user offering his/her credentials to a local agent (e.g., a local Authentication Authorization and Accounting (AAA) client) in order to verify that the user is authorized (e.g., by roaming agreement between the home domain and visited domain (e.g., Internet Service Providers (ISPs))) and to authenticate the user.

In addition, when a user/mobile node is roaming, security associations (SAs) may be set up between the user and agents or entities of the visited domain. For example, a security association may be needed between the user and an access router in the visited domain to protect data (confidentiality and integrity protection) over the access link. As another example, in the context of Mobile Internet Protocol (MIP), an SA may be needed between the mobile node (MN) and the home agent when the mobile node is in the visited domain. As a third example, a security association may also be required between the mobile node and mobility agents when a Localized Mobility Management solution is deployed.

Therefore, a need exists for a method and apparatus that allows a user/mobile node and entities in the network to securely set up and show security keys.

### SUMMARY OF THE INVENTION

Embodiments of the present invention may provide a method of exchanging keys. This may include generating a first Diffie Hellman key at a user (such as a mobile node), transferring the first Diffie Hellman key to a first domain (such as a AAA server in a home domain) and certifying the first key at the first domain. A second key may also be generated at a peer entity and transferred to the first domain. The second key may also be certified at the first domain. After being certified, the first key may be transferred to the peer entity and the second key may be transferred to the user.

The home domain may include an Authentication, Authorization and Accounting server. Communication may also occur with the user by the AAA server through an AAA client. The AAA client may include one of an attendant located in a router, a Registration Agent, and a server located in the second domain.

Embodiments of the present invention may also provide a method of authenticating Diffie Hellman keys. This may include generating and transferring a first Diffie Hellman key from a user (such as a mobile node) to a first domain and generating and transferring a second Diffie Hellman key from an entity in the second domain to a first domain. The entity generating the second Diffie Hellman public key is the node that the user is establishing the shared secret with. The first Diffie Hellman key may be certified in the first domain and the second Diffie Hellman key may also be certified in the first domain.

The AAA infrastructure may be used as a certificate authority to authenticate the Diffie Hellman public key (or value) of the user and the other node.

Embodiments of the present invention may also include a home domain containing at least one server (such as a AAA server). A device (such as a mobile device or node) may also be provided where the device shares a first security association with at least one server in the home domain. A second domain may also be provided where the second domain contains at least one server. A second security association may exist between the at least one server in the home domain and the at least one server in the second domain. The at least one server in the home domain may certify a key of the device and certify a key of the at least one server of the second domain.

Other embodiments and salient features of the invention will become apparent from the following detailed description taken in conjunction with the annexed drawings, which disclose preferred embodiments of the invention.

### BRIEF DESCRIPTION OF THE DRAWINGS

The foregoing and a better understanding of the present invention will become apparent from the following detailed description of example embodiments and the claims when read in connection with the accompanying drawings, all forming a part of the disclosure of this invention. While the foregoing and following written and illustrated disclosure focuses on disclosing example embodiments of the invention, it should be dearly understood that the same is by way of illustration and example only and that the invention is not limited thereto.

Embodiments of the present invention will be described with reference to the following drawings in which like reference numerals refer to like elements and wherein:

FIG. 1 is a diagram of domains and a mobile node according to an example embodiment of the present invention;

FIG. 2 is a flowchart of a key distribution procedure according to an example embodiment of the present invention; and

FIG. 3 is a diagram of a key distribution procedure according to an example embodiment of the present invention.

### DETAILED DESCRIPTION

Before beginning a detailed description of the subject invention, mention of the following is in order. When appropriate, like reference numerals and characters may be used to designate identical, corresponding or similar components in differing figure drawings.

Embodiments of the present invention relate to Mobile IPv6 and other IP networks. The terminology “user” may be used in the following discussion to relate to a device that shares a long-term key with a home domain. This device may be a mobile device such as a mobile telephone. This device does not have to be a mobile device as embodiments of the present invention are also applicable to a mobile host. While embodiments of the present invention may be described with respect to a mobile node (or mobile device), these are merely one example embodiment.

Mobile IP and many of its extensions such as Mobile IPv6 Regional Registration or Hierarchical MIPv6 Mobility Management require strong authentication between a user (also called a mobile node MN) and different agents (i.e., Home Agent, Gateway Mobility Agent, Mobility Anchor Point) that are either located in the Home Domain or in the Visited Domain.

Different key distribution schemes have been introduced to meet these security associations. These key distribution schemes may send a key to the user, encrypted either using a long-term security association between the user and the AAA_h, or using Public keys.

However, in cellular networks, sending the keys encrypted with a long-term security association over an air interface is not acceptable. That is, the wireless link is weak since individuals may eavesdrop thereby making a higher risk to have the key compromised.

Certain key distribution procedures in cellular networks (GSM, UMTS, IS-41) are based on random numbers. In the key distribution mechanisms such as Internet Key Exchange (IKE), keys are not distributed encrypted using a long-term key. That is, Diffie Hellman values may be encrypted but not the keys. Limitations of radio resources must also be taken into account thus raising problems such as certificate revocation, and certificate length. Public key based algorithms are also more time consuming thus creating more delay and more CPU demand.

Embodiments of the present invention may relate to a key distribution procedure based on Diffie Hellman for Mobile IPv6 (or other IP networks). That is, mobile IPv6 requires strong authentication between a mobile node (MN) and its Home agent. Additionally, when extensions to Mobile IPv6, such as Mobile IPv6 Regional Registration or Hierarchical MIPv6 Mobility Management are deployed, security associations between the mobile node and the mobility agents also need to be established.

Embodiments of the present invention provide a mechanism, based on Diffie Hellman, to distribute security keys between a mobile IPv6 node and other entities in a Visited Domain or in a Home Domain.

During a Diffie Hellman exchange, two nodes exchange their Diffie Hellman public values in an authenticated way. More specifically, Diffie-Hellman allows two nodes to derive a shared secret key for use in secret-key cryptography. This may include each node generating a random, secret value that it maintains to itself. Each node may compute a public value, derived mathematically from the random, secret value, and send the public value to the other node. Each node may mathematically combine the public value received from the other node with its own random, secret value.

Due to the mathematical properties involved in the derivation of the public and secret values, the two nodes end up with the same exact combined values at the end of the procedure, which they can use as a shared secret key. In this exchange, the secret values are not disclosed to anyone and therefore only these two nodes can compute the combined value. In this exchange, the secret portions are not disclosed to anyone and therefore only these two nodes can compute the secret value.

However, Diffie-Hellman has vulnerability. Diffie-Hellman does not allow a node to figure out with whom it is establishing that secret key. That is, an intruder on a path between two nodes could fool both nodes into each establishing a key with the intruder rather than each other. To prevent this kind of man-in-the-middle attack, the Diffie Hellman public value must be authenticated.

Embodiments of the present invention may utilize a home AAA server (AAA_h) to perform the authentication. In particular, the user shares a security association (hereafter referred to as Ki) with its Home AAA server (AAA_h). The AAA server in a Visited Domain (AAA_v) also shares a security association (hereafter referred to as K1) with user's Home AAA server (AAA_h). Those two security associations may be used to provide the authentication of the Diffie Hellman exchange. The user and the other entity can thus establish secret keys and be sure with whom they are establishing them. Thus, neither the AAA_h server nor the AAA_server have knowledge of the value of the keys used since the AAA_h is used to authenticate the Diffie Hellman public values. The AAA_h server does not know the Diffie Hellman secret value of the mobile node. This differs from disadvantageous arrangements in which the AAA_h acts as a key distribution center and thereby knows the value of the keys used. When the home agent is assigned in a visited network, the user and the visited domain may not want the home domain to know the value of the key.

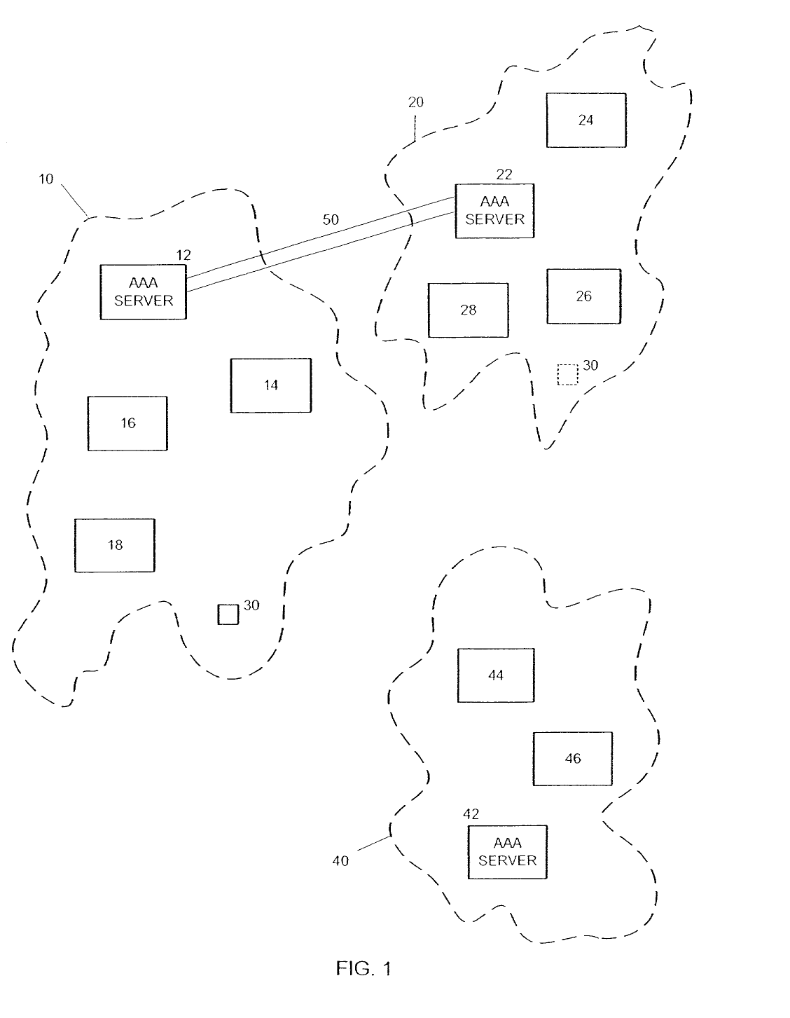

FIG. 1 is a diagram of domains and a user according to an example embodiment of the present invention. Other embodiments are also within the scope of the present invention. FIG. 1 shows three domains 10, 20 and 40. Each domain represents a specific network operated by an Internet Service Provider (ISP). For example, the domain 10 may be operated by ISP 1, the domain 20 may be operated by ISP 2, and the domain 40 may be operated by ISP 4. Each domain 10, 20, 40 may include an Authentication, Authorization and Accounting (AAA) infrastructure composed of AAA nodes (or servers) and AAA clients (12, 22 and 42). Each domain may also include one or more other network nodes or entities that may perform various functions in the domain. The domain 10 includes entities 14-18, the domain 20 includes entities 24-28, and the domain 40 includes entities 44 and 46. These entities may be servers, routers, clients, agents, etc. There may be multiple users with mobile devices (i.e., referred to as mobile nodes), based in each particular domain. For example, a user 30 has its home domain as the domain 10. A AAA server in one domain may have a secure channel with AAA servers in other domains. The AAA node 12 in the domain 10 may have a security association 50 with the AAA node 22 in the domain 20. The security association 50 allows a secure channel to exist for communication of sensitive information. The security association 50 may be used to transmit keys and other information across a secure interface, to authenticate exchanged information. If the user 30 moves from the domain 10 to the domain 20 (i.e., the user 30 shown in dotted lines in the domain 20), the AAA node 22 may use the security association 50 to contact the AAA server 12 in order to authenticate the mobile node 30 in the visited domain 20.

A AAA server may perform a function that allows the user 30 to be authenticated and authorized by a visited network service provider in order to gain access to IP conductivity in the visited domain 20. The user 30 provides its identity and authentication data to the AAA server 26 in the visited network 20, which then may use an AAA infrastructure to authenticate and authorize the user 30 for usage of the visited domain resources, and eventually transport other information. A AAA client may be any of a number of types of entities, for example, an attendant (e.g., located in the default router or access router (i.e., the first router visible to the user in the visited network)), and/or the registration agent of the visited domain.

An AAA infrastructure may be based on a network of AAA entities. A number of protocols may be used that locate an agent 28 (peer-entity) in a visited domain in order to deliver data packets, or exchange protocol-specific signaling messages, with the mobile node 30. Mobile IP, IP paging, and SIP (Session Initiation Protocol) are examples of such protocols.

The home domain and the visited domain share a long-term security association (K1) that is not specific to any particular user and that can be either dynamically set up or established off line as a result of a roaming agreement between the two domains/networks 10 and 20. This security association may be used to exchange information in a secure and mutually authenticated fashion in the two networks 10, 20 by the AAA servers.

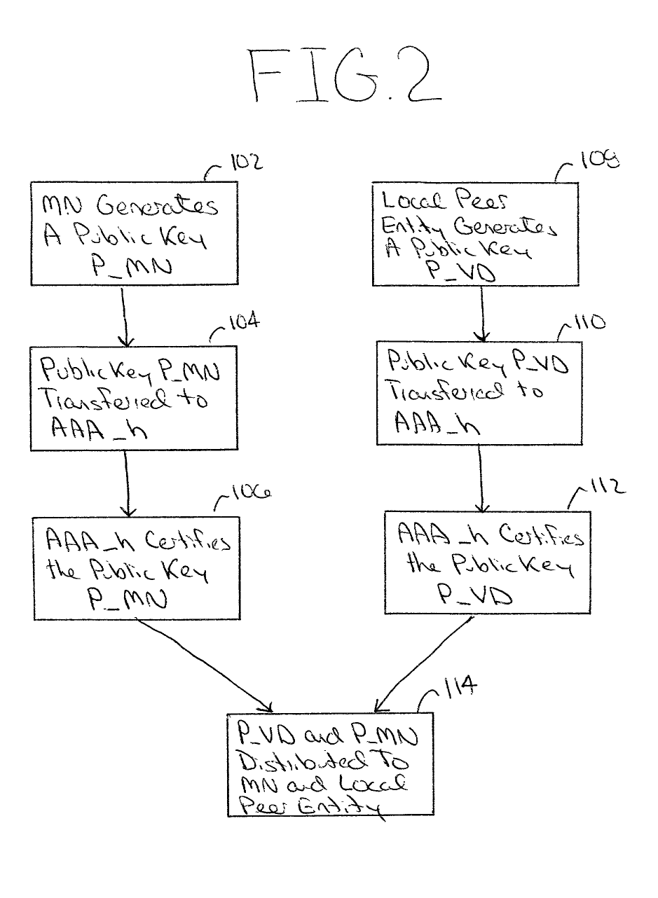

FIG. 2 is a flowchart showing operations of a key distribution procedure according to an example embodiment of the present invention. Other operations, embodiments and orders of operations are also within the scope of the present invention. FIG. 2 is also described with respect to a mobile node (such as a mobile telephone) although embodiments of the present invention are not limited to the user being mobile. FIG. 2 is also described with respect to public keys although embodiments are also applicable to symmetric keys.

As shown in FIG. 2, in block 102, a mobile node (MN) generates a public key (P_MN). The public key P_MN is authenticated using Ki and is transferred to the AAA_h in block 104. This transfer from the MN to the AAA_h may be via the AAA_v. Subsequently, the AAA_h may certify the public key P_MN for the visited domain, authenticating the user's public key using K1 in block 106.

In block 108, the local peer entity (in the visited domain) may generate a public key P_VD. The public key P_VD is authenticated using K1 and transferred to the AAA_h in block 110. This transfer from the local peer entity to the AAA_h may be via the AAA_v. Subsequently, the AAA_h may certify the public key P_VD for the user using Ki in block 112. After the certification by the AAA_h of both the public key P_MN and the public key P_VD, the public keys P_VD and P_MN may be distributed to the MN and the local peer entity in block 114. The entities have therefore exchanged their Diffie Hellman information in an authenticated manner and can therefore derive the shared session key.

Stated in a different way, if the MN wants to set up a security association with an agent (such as a local entity), the MN may send its public Diffie Hellman key P_MN to the AAA_h, using the long-term security association (namely Ki) that the MN shares with its AAA_h, to authenticate the public key (or public Diffie Hellman value) P_MN.

If the agent (such as the local entity) with whom the MN wants to set up a security association is in the visited domain, then the AAA_v may retrieve the agent's Diffie Hellman public value P_VD using intra-domain security and send the public value P_VD using the security association (K1) it shares with the AAA_h, with the message from the MN, to the home network of the MN.

The AAA_h authenticates the Diffie Hellman public values of the agent (P_VD) and Diffie Hellman public value of the MN (P_MN). The AAA_h then sends the MN's Diffie Hellman public value (P_MN) to the AAAᵥ using the security association (K1) it shares with the AAA_v and sends the Agent's Diffie Hellman public value (P_VD) to the MN using the security association (Ki) it shares with the MN.

In this way, the AAA_h is used to authenticate the Diffie Hellman public values. However, since the AAA_h does not have knowledge of the secret values, it can not derive the secret. The AAA_h may be used as a certificate authority thus allowing an easy transition when Public Key Infrastructure (PKI) is deployed. The described method allows the two nodes (i.e., the user and the entity with whom the user wants to set up the security association) to exchange their public Diffie Hellman values in an authenticated manner because of the AAA infrastructure and without requiring the use of public keys by using symmetric keys.

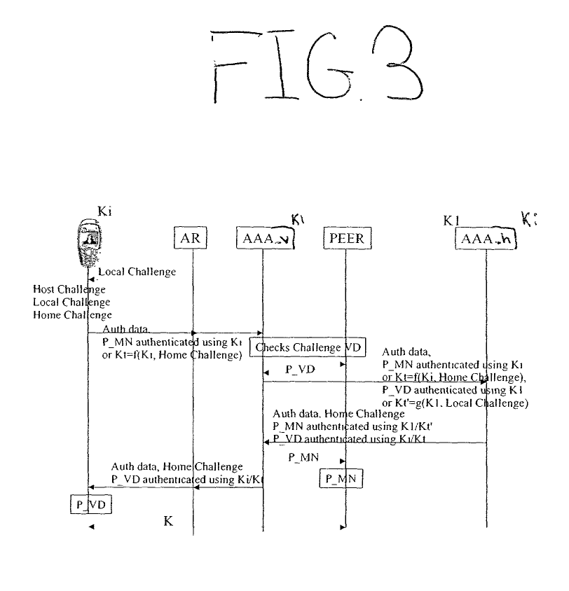

FIG. 3 is a diagram showing how the key distribution procedure described in the embodiment of the present invention can be performed in combination with a mutual challenge response mechanism. Other embodiments and procedures are also within the scope of the present invention. FIG. 3 is also described with respect to a mobile node (such as a mobile telephone) although embodiments of the present invention are not limit to the user being mobile. FIG. 3 is also described with respect to public keys although embodiments are also applicable to symmetric keys.

As shown in FIG. 3, A Local Challenge (LC) is broadcast (e.g. in Router advertisements) by an Access Router (AR). The MN may generate a host challenge for network authentication and take the Host Challenge, Local Challenge, and the Home Challenge to compute authentication data. The MN may send its Diffie Hellman public value (P_MN) authenticated with either Ki or a temporal key (Kt) derived from Ki and the Home Challenge. The AAA_v, when receiving this message, may retrieve the peer entity's Diffie Hellman public value (P_VD) (e.g. the Home agent if assigned in the Visited Domain, or the Mobility Agent if an extension of Mobile IPv6 is deployed). This Diffie Hellman retrieval may be protected using intra-domain security. The AAA_v may then forward the peer entity's Diffie Hellman value (P_VD) to the AAA_h authenticated with K1 or a temporal key (Kt′) derived from K1.

The AAA_h (i.e., the AAA server in the user's home domain) authenticates the user, computes authentication data for network authentication, authenticates the two Diffie Hellman values it received and uses the security association (K1) it shares with the AAA_v to send the user's Diffie Hellman (DH) public value (P_MN) in an authenticated manner and uses the security association (Ki) shared with the user to send the peer entity's Diffie Hellman (DH) public value (P_VD) in an authenticated way. The AAA_h may then generate a Home Challenge for anti replay attacks of the subsequent procedure. The MN and the peer entity receive the other Diffie Hellman public values and thus are able to establish the secret securely.

Embodiments of the present invention relate the exchange of keys (such as symmetric keys, public keys or session keys) between a user (such as a mobile node) and a peer entity. Embodiments of the present invention may use security associations between intermediate servers as a means to provide trust for public key values. A MN may generate a public key (P_MN). The public key is transferred via a AAA_v to the AAA_h. By using the shared secret between the AAA_h and the MN, the P_MN is certified. Similarly, a local peer entity known by the AAA_v may generate a public key (P_VD). The P_VD is transferred via the AAA_v to the AAA_h. By using the shared secret between the AAA_h and the AAA_v, the P_VD is certified. The AAA_h trusts the AAA_v on having certified the P_VD or otherwise having authenticated the local peer prior to obtaining the P_VD. The certified P_VD and P_MN are signed by the AAA_h and distributed to the MN and the local peer entity. Thereafter, the local peer and MN share a key.

Embodiments of the present invention may exchange keys in a IP network. This may involve authenticating a first key (i.e., a user's Diffie Hellman valve) of a user at a first domain and authenticating a second key (i.e., a peer entity's Diffie Hellman valve) of a peer entity at the first domain. The user may utilize a third key (i.e., a shared key between the first domain and the user) to authenticate the first key and transfer the first key to the first domain. The first domain may utilize the third key to authenticate the origin of the received first key and a fourth key (i.e., a shared key between the first domain and a second domain that includes the peer entity) to authenticate the first key and transfer the authenticated first key to the second domain. The second domain may utilize the fourth key to authenticate the second key and transfer the second key to the first domain. The first domain may use the fourth key to authenticate the origin of the received second key and transfer the authenticated second key to the user.

In concluding, any reference in this specification to “one embodiment”, “an embodiment”, “example embodiment”, etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments. Furthermore, for ease of understanding, certain method procedures may have been delineated as separate procedures; however, these separately delineated procedures should not be construed as necessarily order dependent in their performance, i.e., some procedures may be able to be performed in an alternative ordering, simultaneously, etc.

This concludes the description of the example embodiments. Although the present invention has been described with reference to a number of illustrative embodiments thereof, it should be understood that numerous other modifications and embodiments can be devised by those skilled in the art that will fall within the spirit and scope of the principles of this invention. More particularly, reasonable variations and modifications are possible in the component parts and/or arrangements of the subject combination arrangement within the scope of the foregoing disclosure, the drawings and the appended claims without departing from the spirit of the invention. In addition to variations and modifications in the component parts and/or arrangements, alternative uses will also be apparent to those skilled in the art.

What is claimed is:

1. A method of exchanging keys comprising:
generating a first key at a user;
transferring said first key to said first domain;
certifying the first key at a first domain;
generating a second key at peer entity;
transferring said second key to said first domain; and
certifying the second key at said first domain.

2. The method of claim 1, wherein said user and said first domain share a symmetric key.

3. The method of claim 1, wherein said peer entity is located within a second domain, and said second domain and said first domain share a symmetric key.

4. The method of claim 1, wherein said user comprises a mobile node.

5. The method of claim 4, wherein said mobile node is in a visited domain.

6. The method of claim 5, wherein said first domain comprises a home domain.

7. The method of claim 6, wherein said home domain comprises an Authentication, Authorization and Accounting (AAA) server.

8. The method of claim 7, further comprising communicating with said user by the AAA server through an AAA client.

9. The method of claim 8, wherein the AAA client comprises one of an attendant located in a router, a Registration Agent, and a server located in a second domain.

10. The method of claim 1, wherein said first key comprises a first Diffie Hellman value of said user and said second key comprises a second Diffie Hellman value of said user.

11. The method of claim 1, further comprising transferring said first key to said peer entity after certifying said first key.

12. The method of claim 11, further comprising transferring said second key to said user after certifying said second key.

13. A method of exchanging keys comprising:
transferring a first key from a user to a first domain;
generating a second key at a peer entity in a second domain;
transferring said second key to said first domain;
certifying said first key in said first domain; and
certifying said second key in said first domain.

14. The method of claim 13, wherein said user and said first domain share a symmetric key.

15. The method of claim 13, wherein said peer entity is located in a second domain, and said second domain and said first domain share a symmetric key.

16. The method of claim 13, wherein said user is in a visited domain.

17. The method of claim 16, wherein said first domain comprises a home domain.

18. The method of claim 17, wherein said home domain comprises an Authentication, Authorization and Accounting (AAA) server.

19. The method of claim 18, further comprising communicating with the user by the AAA server through an AAA client.

20. The method of claim 19, wherein the AAA client comprises one of an attendant located in a router, a Registration Agent, and a server located in a second domain.

21. The method of claim 13, wherein said first key comprises a first Diffie Hellman value of said user and said second key comprises a second Diffie Hellman value of said peer entity.

22. The method of claim 13, further comprising transferring said second key to said user after certifying said second key.

23. The method of claim 13, further comprising transferring said first key to a peer entity located in a second domain.

24. A system for IP communications comprising:
a home domain, the home domain containing at least one server;
a user sharing a first security association with at least one server in the home domain; and
a second domain, the second domain containing at least one server, a security association existing between the at least one server in the home domain and the at least one server in the second domain, said at least one server in said home domain to certify a key of said user and to certify a key of said at least one server of said second domain.

25. The system of claim 24, wherein said at least one server in said home domain comprises an Authentication, Authorization and Accounting server.

26. The system of claim 25, wherein the AAA server comprises one of an attendant located in a router, a Registration Agent, and a server located in the second domain.

27. The system of claim 24, wherein said user comprises a mobile phone.

28. The system of claim 24, wherein said key of said user comprises a first Diffie Hellman value and said key of said at least one server of said second domain comprises a second Diffie Hellman value.

29. A method of exchanging keys in a IP network comprising:
authenticating a first key of a user at a first domain;
authenticating a second key of a peer entity at said first domain;
transferring said authenticated first key to said peer entity; and
transferring said authenticated second key to said user.

30. The method of claim 29, wherein said user utilizes a third key to authenticate said first key and transfer said first key to said first domain.

31. The method of claim 30, wherein said third key comprises a shared key between said first domain and said user.

32. The method of claim 31, wherein said first domain utilizes said third key to authenticate the origin of said received first key and then utilizes a fourth key to authenticate said first key and transfer said authorized first key to a second domain.

33. The method of claim 32, wherein said fourth key comprises a shared key between said first domain and said second domain that includes said peer entity.

34. The method of claim 32, wherein said second domain utilizes said fourth key to authenticate said second key and transfer said authorized second key to said first domain.

35. The method of claim 34, wherein said first domain utilizes said fourth key to authenticate the origin of said received second key and then utilizes said third key to authenticate said second key and transfer said second key to said user.

36. The method of claim 29, wherein said user comprises a mobile node.

37. The method of claim 29, further comprising generating and authenticating said first key at said user prior to authenticating said first key at said first domain.

38. The method of claim 29, further comprising generating and authenticating said second key at a second domain prior to authenticating said second key at said first domain.

39. The method of claim 29, wherein said first key comprises a Diffie Hellman value of said user, and said second key comprises a Diffie Hellman value of said peer entity.
